(19) United States
(12) Patent Application Publication
(10) Pub. No.: US 2024/0397922 A1
(43) Pub. Date: Dec. 5, 2024

(54) REAR GRIP BASE MATERIAL, REEL SEAT BASE MATERIAL, AND REAR GRIP AND REEL SEAT FORMED BY REAR GRIP BASE MATERIAL AND REEL SEAT BASE MATERIAL

(71) Applicant: Globeride, Inc., Tokyo (JP)

(72) Inventors: Takuji KAWAMURA, Higashikurume-shi (JP); Harunobu Kusumoto, Higashikurume-shi (JP)

(73) Assignee: Globeride, Inc., Tokyo (JP)

(21) Appl. No.: 18/415,876

(22) Filed: Jan. 18, 2024

(30) Foreign Application Priority Data
May 30, 2023 (JP) 2023-088354

(51) Int. Cl. A01K 87/08; B29C 70/16

(52) U.S. Cl. CPC A01K 87/08; B29C 70/16; B29C 43/10

(57) ABSTRACT

A rear grip base material according to an embodiment of the present invention comprises a main body portion, and a tubular fitting adhesion portion which is formed at one end or both ends of the main body portion and to which a rod body is fitted and adhered, and that is used for forming a rear grip of a fishing rod by internal pressure molding. The fitting adhesion portion comprises an innermost layer, an inner diameter adjustment layer, a main body layer, and an outermost layer, and each layer is a fiber-reinforced resin layer.

### CROSS-REFERENCE TO RELATED APPLICATION

This application claims priority under 35 U.S.C. § 119 to Japanese Patent Application No. 2023-088354 filed on May 30, 2023 in the Japanese Patent Office, the entire contents of each hereby incorporated by reference.

### BACKGROUND OF THE INVENTION

### 1. Technical Field

The present invention relates to a rear grip base material, a reel seat base material, and a rear grip and a reel seat formed by the rear grip base material and the reel seat base material.

### 2. Description of the Related Art

In the related art, various fishing rods each including a fishing rod reel seat and a grip have been known.

In such a fishing rod, a fishing rod reel seat and a fishing rod grip are usually placed on a rod body, and a reel leg placing portion for placing a reel leg on an upper side or a lower side of a main body is formed on the fishing rod reel seat.

As a method for forming a tubular body that can be used for such a fishing rod, for example, JP 2023-14787 A discloses a method for manufacturing a tubular body that is an undivided mold including a first step of forming a tubular stacked body extending in an axial direction and having a hollow portion therein by stacking prepregs, a second step of setting the stacked body in a cavity of a mold, and a third step of thermally molding the stacked body by pressing the stacked body against a surface of the cavity while applying a pressure to the hollow portion to expand the stacked body in the cavity. The mold includes a first mold that forms a first range in the axial direction of the cavity, and the first mold does not include a parting line extending in the axial direction on the surface of the cavity.

Furthermore, JP 2004-033638 A discloses a wedge club shaft made of a carbon fiber-reinforced resin. In the carbon fiber-reinforced resin, a bending rigidity of a distal end which is a portion located less than 150 mm from a distal end is set to 3.0×106 kgf·mm² or less, a bending rigidity of a grip attachment portion which is a portion located 650 mm or more from the distal end is set to 7.0×106 kgf·mm² or more, a bending rigidity of a central portion which is a portion located 350 mm or more and less than 500 mm from the distal end gradually increases at a gradient of 7000 to 10000 kgf·mm from the distal end side toward the grip side, and a bending rigidity of a root portion which is a portion located 500 mm or more and less than 650 mm from the distal end gradually increases at a gradient of 12000 to 20000 kgf·mm from the distal end side toward the grip side.

### SUMMARY OF THE INVENTION

The tubular body disclosed in JP 2023-14787 A discloses a method for molding the tubular body in which the pressure is applied to the hollow portion, but does not disclose a method for forming a grip or a reel seat to which tubular bodies having various dimensions are fitted. Even though the grip or the reel seat is molded by the method for molding the tubular body, there is a problem that it is necessary to individually mold the grip and the reel seat according to a desired dimension or shape.

Furthermore, the shaft disclosed in JP 2004-033638 A discloses a method for manufacturing the shaft by internal pressure molding, but does not disclose a method for forming a grip or a reel seat to which shafts having various dimensions are fitted. Even though the grip or the reel seat is molded by the method of manufacturing the shaft, there is a problem that it is necessary to individually mold the grip and the reel seat according to a desired dimension or shape.

The present invention has been made in view of the above circumstances, and an object of the present invention is to provide a rear grip base material, a reel seat base material, and a rear grip and a reel seat formed by the rear grip base material and the reel seat base material which are capable of coping with various dimensions of a rod body of a fishing rod to be fitted and adhered without using a plurality of base materials during internal pressure molding and capable of stabilizing molding quality by providing an inner diameter adjustment layer and using a base material in which fibers of the inner diameter adjustment layer in a circumferential direction easily expand (extend) outward in a radial direction during internal pressure molding. Other objects of the present invention will become apparent upon reference to the entirety of the present specification.

A rear grip base material according to an embodiment of the present invention is a rear grip base material comprises a main body portion, and a tubular fitting adhesion portion which is formed at one end or both ends of the main body portion and to which a rod body is fitted and adhered, and that is used for forming a rear grip of a fishing rod by internal pressure molding. The fitting adhesion portion comprises an innermost layer, an inner diameter adjustment layer, a main body layer, and an outermost layer, and each layer is a fiber-reinforced resin layer.

In the rear grip base material according to the embodiment of the present invention, the innermost layer, the main body layer, and the outermost layer are each formed by a one-turn layer of two or more fiber-reinforced prepreg sheets as viewed in a circumferential direction.

In the rear grip base material according to the embodiment of the present invention, the inner diameter adjustment layer is formed by at least one turn of one or a plurality of fiber-reinforced prepreg sheets as viewed in a circumferential direction.

In the rear grip base material according to the embodiment of the present invention, fibers of the fiber-reinforced resin of the inner diameter adjustment layer are oriented to be inclined with a circumferential direction of the rear grip base material in a range of 20 degrees to 70 degrees.

In the rear grip base material according to the embodiment of the present invention, the inner diameter adjustment layer is formed by a multiple-turn layer of one plain weave or twill weave fabric as viewed in a circumferential direction, and fibers of the one plain weave or twill weave fabric are wound to be diagonally oriented in a range of 20 degrees to 70 degrees with respect to a circumferential direction of the rear grip base material.

In the rear grip base material according to an embodiment of the present invention, a part of the innermost layer is formed to overlap the inner diameter adjustment layer in an axial direction of the rear grip base material.

In the rear grip base material according to an embodiment of the present invention, a part of the innermost layer is formed on an inner surface of the main body layer.

In the rear grip base material according to an embodiment of the present invention, the main body portion of the rear grip base material is formed such that the innermost layer, the main body layer, and the outermost layer extend.

A reel seat base material according to an embodiment of the present invention is a reel seat base material that comprises a main body portion, and a tubular fitting adhesion portion which is formed at one end or both ends of the main body portion and to which a rod body is fitted and adhered, and that is used for forming a reel seat of a fishing rod by internal pressure molding. The fitting adhesion portion comprises an innermost layer, an inner diameter adjustment layer, a main body layer, an outermost layer, and each layer is a fiber-reinforced resin layer.

A rear grip according to an embodiment of the present invention is formed by internal pressure molding by using any one of the rear grip base materials.

A reel seat according to an embodiment of the present invention is formed by internal pressure molding by using the reel seat base material.

According to the embodiment, it is possible to provide a rear grip base material, a reel seat base material, and a rear grip and a reel seat formed by the rear grip base material and the reel seat base material which are capable of coping with various dimensions of a rod body of a fishing rod to be fitted and adhered while suppressing the number of stacked fibers during internal pressure molding and capable of stabilizing molding quality by providing an inner diameter adjustment layer and using a base material in which fibers of the inner diameter adjustment layer in a circumferential direction easily expand (extend) outward in a radial direction during internal pressure molding.

### BRIEF DESCRIPTION OF THE DRAWINGS

FIG. 1A is a diagram illustrating a perspective view of a fishing rod according to an embodiment of the present invention;

FIG. 1B is a diagram illustrating a front view of the fishing rod according to the embodiment of the present invention;

FIG. 2A is a diagram illustrating a perspective view of a rear grip base material 10a according to the embodiment of the present invention;

FIG. 2B is a diagram illustrating a front view of the rear grip base material 10a according to the embodiment of the present invention;

FIG. 3A is a cross-sectional view of the rear grip base material 10a according to the embodiment of the present invention;

FIG. 3B is a cross-sectional view of a layer structure of the rear grip base material 10a according to the embodiment of the present invention;

FIG. 4 is a diagram for describing a method for forming a layer structure of a fitting adhesion portion 3 of the rear grip base material 10a according to the embodiment of the present invention;

FIG. 5 is a diagram for describing diameter expansion of a fiber of fiber-reinforced resin in an inner diameter adjustment layer 5 of the rear grip base material 10a according to the embodiment of the present invention;

FIG. 6 illustrates a part of a cross-sectional view of the rear grip base material 10a according to the embodiment of the present invention;

FIG. 7A is a perspective view of a reel seat base material 9a according to the embodiment of the present invention; and

FIG. 7B is a diagram illustrating a front view of the reel seat base material 9a according to the embodiment of the present invention.

### DETAILED DESCRIPTION

Hereinafter, an embodiment of a fishing rod according to the present invention will be specifically described with reference to the accompanying drawings. Components common in a plurality of drawings are assigned with the same reference signs throughout the plurality of drawings. It should be noted that the drawings are not always illustrated in a precise aspect ratio for the sake of convenience in description.

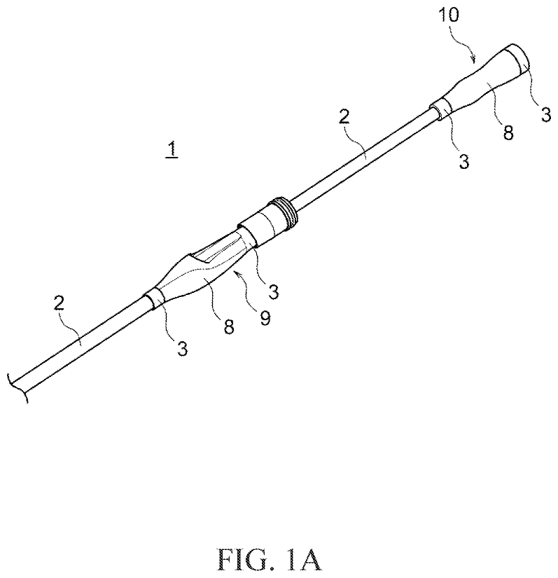

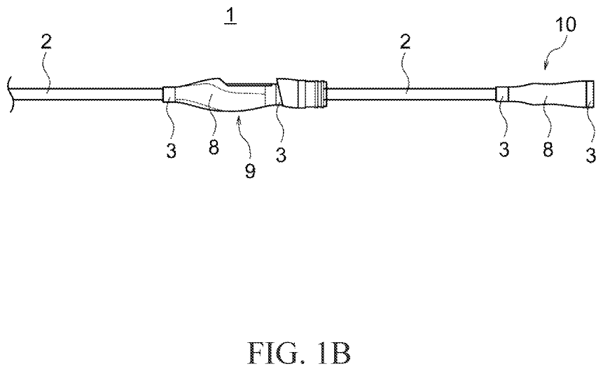

FIGS. 1A and 1B illustrate the embodiment of the fishing rod according to the present invention, FIG. 1A illustrates a perspective view of the fishing rod according to the embodiment of the present invention, and FIG. 1B illustrates a front view of the fishing rod according to the embodiment of the present invention. As illustrated in the drawing, a fishing rod 1 according to the embodiment of the present invention comprises a rod body 2, a reel (not illustrated) attached to the rod body 2 via a reel seat 9, a fishing line guide (not illustrated) attached to the rod body 2, and a rear grip 10 formed at a rear end of the rod body. In the illustrated embodiment, the reel seat 9, the rear grip 10, and the fishing line guide (not illustrated) correspond to attachment components attached to an outer peripheral surface of the rod body.

Although not illustrated, the rod body 2 is formed by, for example, connecting a base rod, a middle rod, a tip rod, and the like to each other. These rod bodies are jointed to each other, for example, as an ordinarily jointed type. The base rod, the middle rod, and the tip rod can be jointed to each other as a telescopic type, an inversely jointed type, a socket-and-spigot jointed type, or any other known joined type. The rod body 2 may comprise a single rod body.

The base rod, the middle rod, and the tip rod each comprises, for example, a tubular body made of a fiber-reinforced resin. This tubular body made of a fiber-reinforced resin is formed by winding a fiber-reinforced resin prepreg (prepreg sheet) in which reinforcing fibers are impregnated with a matrix resin around a core metal, and heating and curing the prepreg sheet. As the reinforcing fibers contained in the prepreg sheet, for example, carbon fibers, glass fibers, and any other known reinforcing fibers can be used. As the matrix resin contained in the prepreg sheet, a thermosetting resin such as an epoxy resin can be used. After the prepreg sheet is cured, the core metal is removed. Furthermore, an outer surface of the tubular body is appropriately polished. Each of the rod bodies may be formed in a solid state. Similarly, although not illustrated, a plurality of fishing line guides for guiding a fishing line fed from the reel (not illustrated) attached to the reel seat 9 are provided in the base rod, the middle rod, and the tip rod.

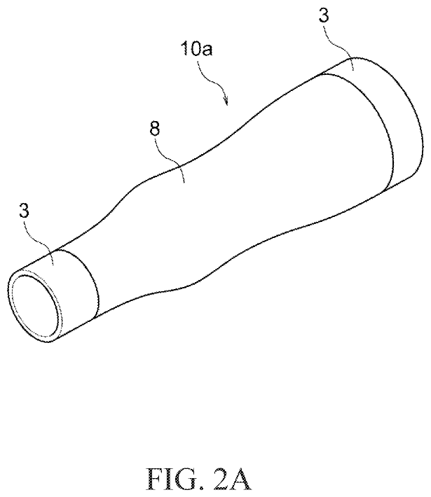

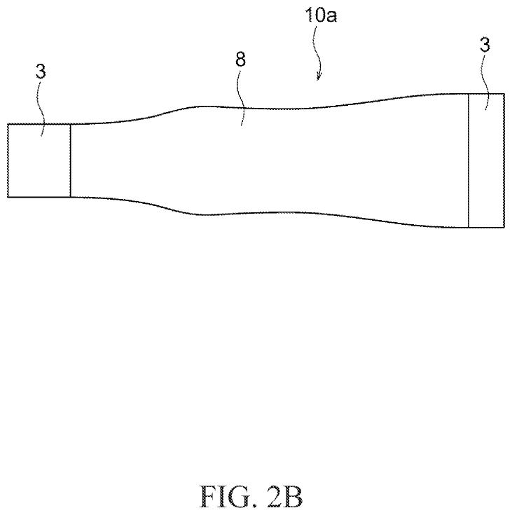

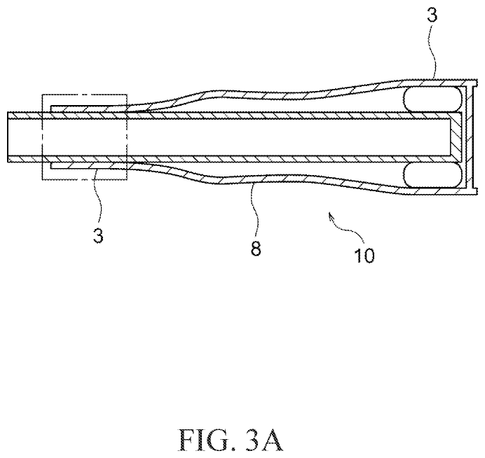

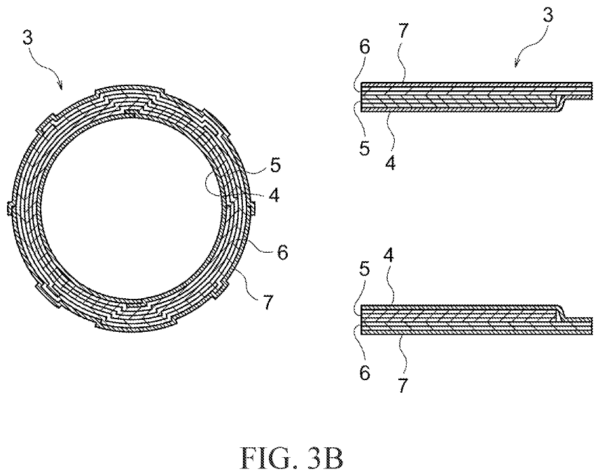

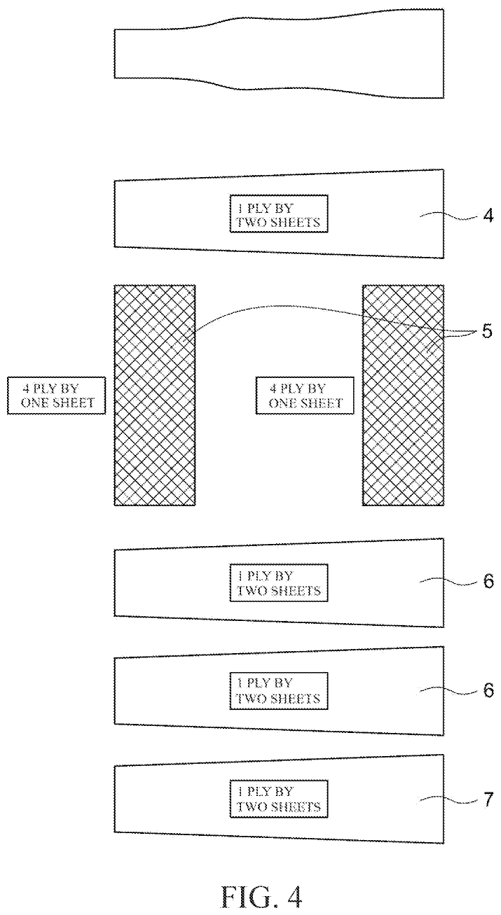

Next, a rear grip base material 10a according to the embodiment of the present invention will be described with reference to FIGS. 2, 3, and 4. FIGS. 2A and 2B illustrate an appearance of the rear grip base material 10a according to the embodiment of the present invention, FIG. 2A illustrates a perspective view of the rear grip base material 10a according to the embodiment of the present invention, and FIG. 2B illustrates a front view of the rear grip base material 10a according to the embodiment of the present invention. Furthermore, FIGS. 3A and 3B are diagram for describing an internal structure of the rear grip base material 10a according to the embodiment of the present invention, FIG. 3A illustrates a cross-sectional view of the rear grip base material 10a according to the embodiment of the present invention, and FIG. 3B illustrates a cross-sectional view of a layer structure of the rear grip base material 10a according to the embodiment of the present invention. FIG. 4 is a diagram for describing a method for forming a layer structure of the fitting adhesion portion 3 of the rear grip base material 10a according to the embodiment of the present invention.

As illustrated in FIGS. 2A to 3B, the rear grip base material 10a according to the embodiment of the present invention comprises a main body portion 8, and a tubular fitting adhesion portion 3 which is formed at one end or both ends (in the case illustrated in FIGS. 3A and 3B) of the main body portion 8 and to which the rod body 2 is fitted and adhered, and is the rear grip base material 10a for forming the rear grip 10 of the fishing rod 1 by internal pressure molding. The fitting adhesion portion 3 comprises an innermost layer 4, an inner diameter adjustment layer 5, a main body layer 6, and an outermost layer 7, and each layer is a fiber-reinforced resin layer.

According to the rear grip base material 10a according to the embodiment of the present invention, the inner diameter adjustment layer 5 is provided, and a base material in which fibers of the inner diameter adjustment layer 5 in a circumferential direction easily expand (extend) outward in a radial direction during internal pressure molding is used. Thus, it is possible to provide the rear grip base material capable of coping with various dimensions of the rod body of the fishing rod to be fitted and adhered while the number of stacked fibers during internal pressure molding and capable of stabilizing molding quality.

Next, the layer structure of the fitting adhesion portion 3 of the rear grip base material 10a according to the embodiment of the present invention will be described with reference to FIG. 4. As illustrated in FIG. 4, in the rear grip base material 10a according to the embodiment of the present invention, the innermost layer 4, the main body layer 6, and the outermost layer 7 are each formed by a one-turn layer of two or more fiber-reinforced prepreg sheets as viewed in a circumferential direction of the rear grip base material 10a. As a result, even though patterns are disposed and stacked in any fiber direction, a diameter of the pattern is easily expanded in the circumferential direction due to an internal pressure, and rigidity and strength can be freely changed.

Furthermore, as illustrated in FIG. 4, in the rear grip base material 10a according to the embodiment of the present invention, the inner diameter adjustment layer 5 is formed by at least one turn of one or a plurality of fiber-reinforced prepreg sheets as viewed in the circumferential direction of the rear grip base material 10a. As a result, since any thick layer can be formed without using a plurality of patterns, not only time and effort of a pattern stacking work are saved, but also there is no partial overlap between patterns during winding. Thus, uniform physical properties can be secured.

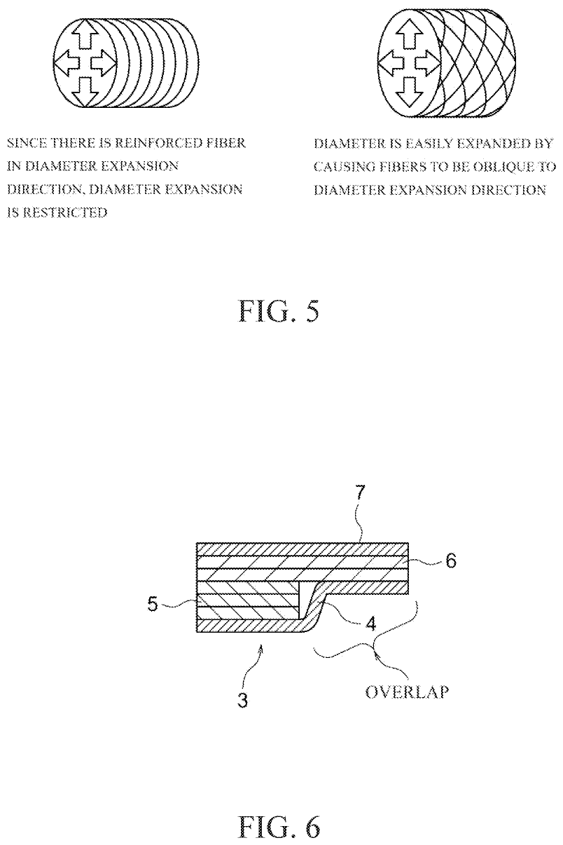

In the rear grip base material 10a according to the embodiment of the present invention, the fiber-reinforced resin fibers of the inner diameter adjustment layer 5 are oriented to be inclined in a range of 20 degrees to 70 degrees with respect to the circumferential direction of the rear grip base material 10a. As illustrated in FIG. 5, the fibers are diagonally oriented with respect to a diameter expansion direction, and thus, it is possible to obtain a molding pressure sufficient to press the fibers against an outer mold during internal pressure molding. As described above, according to the rear grip base material 10a according to the embodiment of the present invention, the inner diameter adjustment layer 5 is provided, and a base material in which fibers of the inner diameter adjustment layer 5 in a circumferential direction easily expand (extend) outward in a radial direction during internal pressure molding is used. Thus, it is possible to provide the rear grip base material capable of coping with various dimensions of the rod body of the fishing rod to be fitted and adhered while the number of stacked fibers during internal pressure molding and capable of stabilizing molding quality.

In the rear grip base material 10a according to the embodiment of the present invention, the inner diameter adjustment layer 5 is formed by a multiple-turn layer of one plain weave or twill weave fabric as viewed in the circumferential direction of the rear grip base material 10a, and fibers of the one plain weave or twill weave fabric are wound to be diagonally oriented with respect to the circumferential direction of the rear grip base material in a range of 20 degrees to 70 degrees. As illustrated in FIG. 5, the fibers are diagonally oriented with respect to a diameter expansion direction, and thus, it is possible to obtain a molding pressure sufficient to press the fibers against an outer mold during internal pressure molding. Furthermore, since any thick layer can be formed without using a plurality of patterns, not only time and effort of a pattern stacking work are saved, but also there is no partial overlap between patterns during winding. Thus, uniform physical properties can be secured. As described above, according to the rear grip base material 10a according to the embodiment of the present invention, the inner diameter adjustment layer 5 is provided, and a base material in which fibers of the inner diameter adjustment layer 5 in a circumferential direction easily expand (extend) outward in a radial direction during internal pressure molding is used. Thus, it is possible to provide the rear grip base material capable of coping with various dimensions of the rod body of the fishing rod to be fitted and adhered while the number of stacked fibers during internal pressure molding and capable of stabilizing molding quality.

As illustrated in FIG. 6, in the rear grip base material 10a according to the embodiment of the present invention, a part of the innermost layer 4 is formed to overlap the inner diameter adjustment layer 5 in an axial direction of the rear grip base material 10a. As described above, since an end of the inner diameter adjustment layer is covered with a continuous base material, the stacking step can be alleviated, protrusion of an internal pressure tube is reduced during internal pressure molding. The molding pressure is sufficiently applied to the base material, and thus, it is possible to easily obtain a molded layer of stable quality.

Furthermore, as illustrated in FIG. 6, in the rear grip base material 10a according to the embodiment of the present invention, a part of the innermost layer 4 is formed on an inner surface of the main body layer. As described above, since an end of the inner diameter adjustment layer is covered with a continuous base material, the stacking step can be alleviated, protrusion of an internal pressure tube is reduced during internal pressure molding. The molding pressure is sufficiently applied to the base material, and thus, it is possible to easily obtain a molded layer of stable quality.

In the rear grip base material 10a according to the embodiment of the present invention, the main body portion 8 of the rear grip base material 10a is formed such that the innermost layer 4, the main body layer 6, and the outermost layer 7 extend. As described above, it is possible to obtain a pattern configuration in which stable quality can be easily obtained and any rigidity.

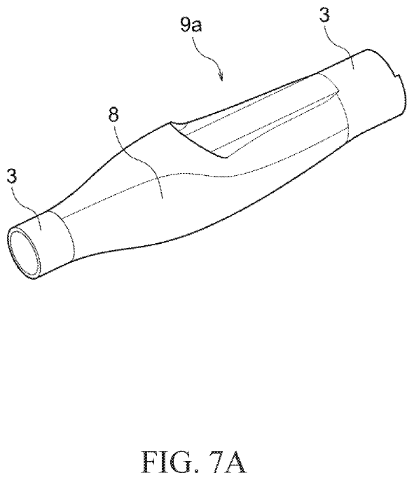

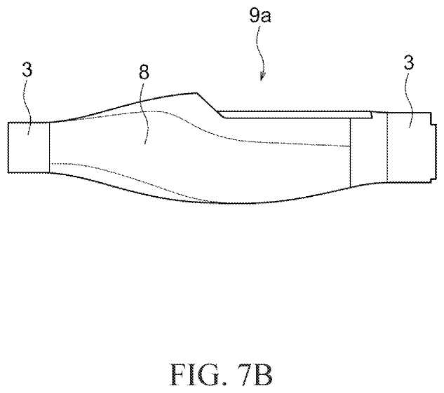

Next, a reel seat base material 9a according to the embodiment of the present invention will be described with reference to FIGS. 7A, 7B, 3A, and 3B. FIG. 7A illustrates a perspective view of the reel seat base material 9a according to the embodiment of the present invention, and FIG. 7B illustrates a front view of the reel seat base material 9a according to the embodiment of the present invention. Furthermore, FIGS. 3A and 3B are diagram for describing the internal structure of the rear grip base material 10a according to the embodiment of the present invention, FIG. 3A illustrates a cross-sectional view of the rear grip base material 10a according to the embodiment of the present invention, and FIG. 3B illustrates a cross-sectional view of the layer structure of the rear grip base material 10a according to the embodiment of the present invention. However, since the rear grip base material is common to the reel seat base material 9a according to the embodiment of the present invention, the description is made with reference to FIG. 3.

The reel seat base material 9a according to the embodiment of the present invention is a reel seat base material 9a that comprises a main body portion 8 and a tubular fitting adhesion portion 3 which is formed at one end or both ends (in the case illustrated in FIGS. 7A, 7B, 3A, and 3B) of the main body portion 8 and to which the rod body 2 is fitted and adhered, and is the reel seat base material 9a for forming the reel seat 9 of the fishing rod 1 by internal pressure molding. The fitting adhesion portion 3 comprises an innermost layer 4, an inner diameter adjustment layer 5, a main body layer 6, and an outermost layer 7, and each layer is a fiber-reinforced resin layer. As described above, according to the reel seat base material 9a according to the embodiment of the present invention, the inner diameter adjustment layer 5 is provided, and a base material in which fibers of the inner diameter adjustment layer 5 in a circumferential direction easily expand (extend) outward in a radial direction during internal pressure molding is used. Thus, it is possible to provide the reel seat base material capable of coping with various dimensions of the rod body of the fishing rod to be fitted and adhered while the number of stacked fibers during internal pressure molding and capable of stabilizing molding quality.

Here, it is additionally mentioned that aspects of the rear grip base material 10a according to the embodiment of the present invention described above are also similar to the aspects of the reel seat base material 9a according to the embodiment of the present invention.

The rear grip 10 according to the embodiment of the present invention is formed by internal pressure molding by using the rear grip base material 10a according to the embodiment of the present invention described above. As described above, according to the rear grip 10 according to the embodiment of the present invention, the inner diameter adjustment layer 5 is provided, and a base material in which fibers of the inner diameter adjustment layer 5 in a circumferential direction easily expand (extend) outward in a radial direction during internal pressure molding is used. Thus, it is possible to provide the rear grip 10 capable of coping with various dimensions of the rod body of the fishing rod to be fitted and adhered while the number of stacked fibers during internal pressure molding and capable of stabilizing molding quality.

The reel seat 9 according to the embodiment of the present invention is formed by internal pressure molding by using the reel seat base material 9a according to the embodiment of the present invention described above. As described above, according to the reel seat 9 according to the embodiment of the present invention, the inner diameter adjustment layer 5 is provided, and a base material in which fibers of the inner diameter adjustment layer 5 in a circumferential direction easily expand (extend) outward in a radial direction during internal pressure molding is used. Thus, it is possible to provide the reel seat 9 capable of coping with various dimensions of the rod body of the fishing rod to be fitted and adhered while the number of stacked fibers during internal pressure molding and capable of stabilizing molding quality.

Next, a method for molding the reel seat 9 according to the embodiment of the present invention and the rear grip 10 according to the embodiment of the present invention will be described. In the method for molding the reel seat 9 according to the embodiment of the present invention and the rear grip 10 according to the embodiment of the present invention, for example, the rear seat and the rear grip are molded by stacking a thermosetting prepreg (preform) around a material to which an internal pressure is applied, such as a tube, placing the preform in a die having a good shape, and applying the internal pressure by using air, a liquid, a powder that thermally expands while being heated by a press machine after clamping. After the molding, the material or the like used in an internal pressure step is removed to complete the rear grip 10 or the reel seat 9 having a hollow structure.

Note that, the method for molding the reel seat 9 according to the embodiment of the present invention and the rear grip 10 according to the embodiment of the present invention described above can also be applied to other grips and the like, and exhibits the technical effects described above.

The dimension, material, and disposition of each component described in the present specification are not limited to those explicitly described in the embodiment, and each component can be modified to have any dimension, material, and disposition that are within the scope of the present invention. Furthermore, components not explicitly described in the present specification can also be added to the described embodiment, or some of the components described in each embodiment can also be omitted.

REFERENCE SIGNS LIST

| | |
|---|---|
| 1 | fishing rod |
| 2 | rod body |
| 3 | fitting adhesion portion |
| 4 | innermost layer |
| 5 | inner diameter adjustment layer |
| 6 | main body layer |
| 7 | outermost layer |
| 8 | main body portion |
| 9 | reel seat |
| 9a | reel seat base material |
| 10 | rear grip |
| 10a | rear grip base material |

What is claimed is:

1. A rear grip base material comprising a main body portion, and a tubular fitting adhesion portion which is formed at one end or both ends of the main body portion and to which a rod body is fitted and adhered, and that is used for forming a rear grip of a fishing rod by internal pressure molding,
the fitting adhesion portion comprising an innermost layer, an inner diameter adjustment layer, a main body layer, and an outermost layer, and each layer being a fiber-reinforced resin layer.

2. The rear grip base material according to claim 1, wherein the innermost layer, the main body layer, and the outermost layer are each formed by a one-turn layer of two or more fiber-reinforced prepreg sheets as viewed in a circumferential direction.

3. The rear grip base material according to claim 1, wherein the inner diameter adjustment layer is formed by at least one turn of one or a plurality of fiber-reinforced prepreg sheets as viewed in a circumferential direction.

4. The rear grip base material according to claim 3, wherein fibers of the fiber-reinforced resin of the inner diameter adjustment layer are oriented to be inclined with a circumferential direction of the rear grip base material in a range of 20 degrees to 70 degrees.

5. The rear grip base material according to claim 1, wherein the inner diameter adjustment layer is formed by a multiple-turn layer of one plain weave or twill weave fabric as viewed in a circumferential direction, and fibers of the one plain weave or twill weave fabric are wound to be diagonally oriented in a range of 20 degrees to 70 degrees with respect to a circumferential direction of the rear grip base material.

6. The rear grip base material according to claim 1, wherein a part of the innermost layer is formed to overlap the inner diameter adjustment layer in an axial direction of the rear grip base material.

7. The rear grip base material according to claim 1, wherein a part of the innermost layer is formed on an inner surface of the main body layer.

8. The rear grip base material according to claim 1, wherein the main body portion of the rear grip base material is formed such that the innermost layer, the main body layer, and the outermost layer extend.

9. A reel seat base material comprising a main body portion, and a tubular fitting adhesion portion which is formed at one end or both ends of the main body portion and to which a rod body is fitted and adhered, and that is used for forming a reel seat of a fishing rod by internal pressure molding,
the fitting adhesion portion comprising an innermost layer, an inner diameter adjustment layer, a main body layer, an outermost layer, and each layer being a fiber-reinforced resin layer.

10. A rear grip formed by internal pressure molding by using the rear grip base material according to claim 1.

11. A reel seat formed by internal pressure molding by using the reel seat base material according to claim 9.
